(19) United States
(12) Patent Application Publication
(10) Pub. No.: US 2026/0320624 A1
(43) Pub. Date: Oct. 15, 2026

(54) SYSTEMS AND METHODS FOR IDENTIFICATION OF FALSE DUPLICATE CONSIGNEES IN A RECALL PROCESS

(71) Applicant: Honeywell International Inc., Charlotte, NC (US)

(72) Inventors: Ankit Singh, Apex, NC (US); Waad Subber, Schenectady, NY (US); Lakshminarayana Paila, Frisco, TX (US)

(21) Appl. No.: 19/174,968

(22) Filed: Apr. 10, 2025

(51) Int. Cl. G06Q 30/014; G06F 16/215

(52) U.S. Cl. CPC G06Q 30/014; G06F 16/215

(57) ABSTRACT

A system and method for identification of false duplicate consignees in a recall process is disclosed. The system comprises a storage and at least one processor coupled to the storage. The processor is configured to classify a plurality of consignees into a first list and a second list, wherein the first list comprises one or more unique consignees and the second list comprises one or more duplicate consignees from amongst the plurality of consignees. Further, the processor is configured to obtain metadata associated with the one or more duplicate consignees comprised in the second list. Further, the processor is configured to select for each of the one or more duplicate consignees, at least one false duplicate verification rule from a plurality of false duplicate verification rules that is to be used for determining a veracity of the one or more duplicate consignees present in the second list, based on the metadata associated with each of the said one or more duplicate consignees. Further, the processor is configured to apply the selected at least one false duplicate verification rule on each of the one or more duplicate consignees present in the second list to determine whether a false duplicate consignee is present in the second list, wherein the false duplicate consignee is a unique consignee which is erroneously deemed as a duplicate consignee.

### TECHNICAL FIELD OF THE INVENTION

The present subject matter relates to recall management system and, more particularly, to systems and methods for identification of false duplicate consignees in a recall process.

### BACKGROUND OF THE INVENTION

Recall execution is a critical process across various industries, including automotive, consumer electronics, food and beverage, medicines, medical devices, etc. When an organization decides to recall the product, they understand the landscape of impacted consignees and send out communications to them via email electronically with a form that needs to be filled out by the consignees where they explicitly state how many batches they are returning/disposing per the manufacturer instructions so that the manufacturer can correctly track the effectiveness of the recall. Based on consolidating responses from various consignees, the recall effectiveness success rate can be measured for safety, compliance & regulatory reasons. The existing solution addresses the problem of accurate measurement for Recall effectiveness, but the solution is not available where same consignee human person may need to be sent multiple notices and they must not be treated as duplicate consignees while performing the consignee check in a database.

The present subject matter discloses methods and system for identifying such false positive scenarios where the consignees using the conventional database monitoring for identification of duplicate consignees and may be presented as false duplicate consignees to the recall project manager.

### SUMMARY OF THE INVENTION

The present subject matter provides systems and methods for identification of false duplicate consignees in a recall process.

In an embodiment, a method for identification of false duplicate consignees in a recall process is disclosed. The method includes classifying, by a processor using a duplication check technique, a plurality of consignees into a first list and a second list, wherein the first list comprises one or more unique consignees and the second list comprises one or more duplicate consignees from amongst the plurality of consignees. Further, the method includes obtaining, by the processor from a storage, metadata associated with the one or more duplicate consignees comprised in the second list. Further, the method includes selecting, by the processor, for each of the one or more duplicate consignees, at least one false duplicate verification rule from a plurality of false duplicate verification rules that is to be used for determining a veracity of the one or more duplicate consignees present in the second list, based on the metadata associated with each of the said one or more duplicate consignees. The method further includes applying, by the processor, the selected at least one false duplicate verification rule on each of the one or more duplicate consignees present in the second list to determine whether a false duplicate consignee is present in the second list, wherein the false duplicate consignee is a unique consignee which is erroneously deemed as a duplicate consignee.

In some embodiments, the metadata associated with the one or more duplicate consignees comprises at least one of: a consignee address or a consignee geographical area code or consignee landline number, a consignee type, a consignee billing code, a consignee department-specific identifier, a consignee batch scan information, a consignee telephone contact information, and consignee media updates.

In some embodiments, the metadata associated with the one or more duplicate consignees comprises consignee type as one of: a doctor and a physician, wherein the selected at least one false duplicate verification rule is based on the consignee type. In said embodiment, applying comprises for each of the one or more duplicate consignees: querying at least one of: a National Provider Identifier (NPI) Database to determine whether at least two NPIs corresponding to the duplicate consignee exist in the NPI database and a Drug Enforcement Administration (DEA) database to determine whether at least two DEAs identifiers corresponding to the duplicate consignee exist in the DEA database. Further, when it is determined that at least two NPIs/DEA identifiers exist corresponding to the duplicate consignee, the applying further includes determining whether an NPI/DEA identifier corresponding to the duplicate consignee is different than an NPI/DEA identifier corresponding to the unique consignee which corresponds to the duplicate consignee. Further, the applying comprises identifying the duplicate consignee as a false duplicate consignee when it is determined that the NPI/DEA identifier corresponding to the duplicate consignee is different than the NPI/DEA identifier corresponding to the unique consignee which corresponds to the duplicate consignee.

In some embodiments, the metadata associated with the one or more duplicate consignees comprises a consignee address or a consignee geographical area code or consignee landline number, wherein the selected at least one false duplicate verification rule is based on the on the consignee consignee address or the consignee geographical area code or the consignee landline number. In said embodiment, applying comprises for each of the one or more duplicate consignees, determining whether a consignee address or a consignee geographical area code or consignee landline number of the duplicate consignee is different than a consignee address or a consignee geographical area code or consignee landline number of a unique consignee corresponding to the duplicate consignee. The applying further comprises identifying the duplicate consignee as a false duplicate consignee when it is determined that the consignee address or a consignee geographical area code or consignee landline number of the duplicate consignee is different than the respective consignee address or a consignee geographical area code or consignee landline number corresponding to the duplicate consignee.

In some embodiments, the metadata associated with the one or more duplicate consignees comprises at least one of: a consignee billing code or a consignee department-specific identifier, wherein the selected at least one false duplicate verification rule is based on at least one of: the consignee billing code or the consignee department-specific identifier. In said embodiment, applying comprises for each of the one or more duplicate consignees, determining whether at least one of a consignee billing code or a consignee department-specific identifier of the duplicate consignee is different than a consignee billing code or a consignee department-specific identifier of a unique consignee corresponding to the duplicate consignee. The applying further comprises identifying the duplicate consignee as a false duplicate consignee when it is determined that at least one of the consignee billing code or the consignee department-specific identifier of the duplicate consignee is different than the consignee billing code or the consignee department-specific identifier of the unique consignee corresponding to the duplicate consignee.

In some embodiments, the metadata associated with the one or more duplicate consignees comprises consignee batch scan information, wherein the consignee batch scan information comprises information about one or more geographic locations where one or more historic batches of consignments were scanned, wherein the selected at least one false duplicate verification rule is based on the consignee batch scan information. In said embodiment, applying comprises for each of the one or more duplicate consignees, determining whether the consignee batch scan information is different than a consignee batch scan information of a unique consignee corresponding to the duplicate consignee. The applying further comprises identifying the duplicate consignee as a false duplicate consignee when it is determined that the consignee batch scan information of the duplicate consignee is different than the consignee batch scan information of the unique consignee corresponding to the duplicate consignee.

In some embodiments, the metadata associated with the one or more duplicate consignees comprises consignee media information, wherein the consignee media information comprises consignee name change update or consignee merger and acquisition update, wherein the selected at least one false duplicate verification rule is based on the consignee media information. In said embodiment, applying comprises for each of the one or more duplicate consignees, determining the consignee's name or consignee merger and acquisition's update for a unique consignee corresponding to the duplicate consignee. The applying further comprises identifying the duplicate consignee as a false duplicate consignee when it is determined that the consignee's name or consignee merger and acquisition's update are different for the unique consignee corresponding to the duplicate consignee.

In an embodiment, a system for identification of false duplicate consignees in a recall process is provided. The system comprises processor configured to classify a plurality of consignees into a first list and a second list, wherein the first list comprises one or more unique consignees and the second list comprises one or more duplicate consignees from amongst the plurality of consignees. The processor is further configured to obtain metadata associated with the one or more duplicate consignees comprised in the second list. Further, the processor is configured to select for each of the one or more duplicate consignees, at least one false duplicate verification rule from a plurality of false duplicate verification rules that is to be used for determining a veracity of the one or more duplicate consignees present in the second list, based on the metadata associated with each of the said one or more duplicate consignees. The processor is also configured to apply the selected at least one false duplicate verification rule on each of the one or more duplicate consignees present in the second list to determine whether a false duplicate consignee is present in the second list, wherein the false duplicate consignee is a unique consignee which is erroneously deemed as a duplicate consignee.

In yet another embodiment, a computer-readable medium having computer-executable instructions stored thereon is disclosed. The computer-executable instructions, when executed by a processing system, cause the processing system to classify a plurality of consignees into a first list and a second list, wherein the first list comprises one or more unique consignees and the second list comprises one or more duplicate consignees from amongst the plurality of consignees. Further, the computer-executable instructions cause the processing system to obtain metadata associated with the one or more duplicate consignees comprised in the second list. The computer-executable instructions further cause the processing system to select for each of the one or more duplicate consignees, at least one false duplicate verification rule from a plurality of false duplicate verification rules that is to be used for determining a veracity of the one or more duplicate consignees present in the second list, based on the metadata associated with each of the said one or more duplicate consignees. Furthermore, the computer-executable instructions cause the processing system to apply the selected at least one false duplicate verification rule on each of the one or more duplicate consignees present in the second list to determine whether a false duplicate consignee is present in the second list, wherein the false duplicate consignee is a unique consignee which is erroneously deemed as a duplicate consignee.

The systems and methods described above provide an efficient solution for identifying and removing false duplicate consignees in a consignment recall process. The removal of false duplicate consignees ensures that the list of duplicate consignees presented to the recall project manager is accurate and free from false entries. Accordingly, the consignment recall process initiated based on said list helps in mitigating duplicate information processing at the manufacturer and vendor ends and reduces operational time associated with the recall process, thereby improving operational efficiency and improving recall effectiveness.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates a system for identification of false duplicate consignees in a recall process, according to one or more embodiments of the present disclosure.

FIG. 2 illustrates a block diagram of computing device for identification of false duplicate consignees in a recall process, according to one or more embodiments of the present disclosure.

FIG. 3 illustrates a flowchart of a method 300 for determining a veracity of one or more duplicate consignees which are classified in a duplicate consignee list in a recall process., according to one or more embodiments of the present disclosure.

FIG. 4 is a flowchart illustrating a method 400 for determining a veracity of one or more duplicate consignees which are classified in a duplicate consignee list in a recall process, according to one or more embodiments of the present disclosure.

FIG. 5 is a flowchart illustrating a method 500 for determining a veracity of one or more duplicate consignees which are classified in a duplicate consignee list in a recall process, according to one or more embodiments of the present disclosure

FIG. 6 is a flowchart illustrating a method 600 for determining a veracity of one or more duplicate consignees which are classified in a duplicate consignee list in a recall process, according to one or more embodiments of the present disclosure

FIG. 7 is a flowchart illustrating a method 700 for determining a veracity of one or more duplicate consignees which are classified in a duplicate consignee list in a recall process, according to one or more embodiments of the present disclosure.

FIG. 8 is a flowchart illustrating a method 800 for determining a veracity of one or more duplicate consignees which are classified in a duplicate consignee list in a recall process, according to one or more embodiments of the present disclosure.

FIG. 9A-9E illustrates use cases depicting implementations of the system 102, according to some embodiments of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

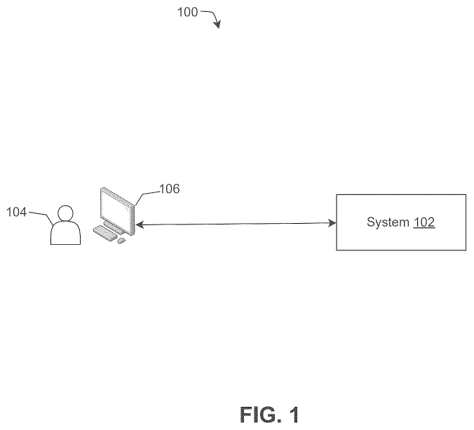

FIG. 1 illustrates an environment 100 implementing a system 102 for identification of false duplicate consignees in a recall process, according to one or more embodiments of the present subject matter. The term false duplicate consignees, as used herein, may be understood as consignees which have been mistakenly identified as duplicates in the context of a recall process, even though they are distinct and should be treated as separate consignees. For instance, consider a case where a consignee A has two addresses, i.e., Address 1 and Address 2, and received a product B at both these addresses. A conventional system implemented for identifying duplicate consignees during recall process may incorrectly identify such a consignee as a duplicate consignee in case the product B is recalled. The conventional system may analyze the name of the consignees to whom the product B was delivered and may ascertain that two entries with the same name of consignee A are appearing in records. Thus, in this case, the conventional system may classify one entry of the consignee A as a duplicate consignee. However, as the product B was delivered at two different addresses of the consignee A, the corresponding entries are unique entries and the duplicate consignee entry was erroneously done by the conventional system. Said entry is thus understood to be a false duplicate consignee.

The system 102 may be implemented as a solution service by a service provider to aid product manufacturing companies to efficiently carry out product recall processes. For instance, a pharmaceutical company may subscribe to the services of the system 102 and may utilize the same in order to identify false duplicate consignees during a recall process for a medicine sold to a plurality of consignees, such as medical shops or doctors. Likewise, a hardware product company may subscribe to the services of the system 102 and may utilize the same in order to identify false duplicate consignees during a recall process of a product, say a chair, sold to a plurality of consignees, such as organizations, users, etc. In some embodiments, the product companies may take a subscription to the services of the system 102. In some embodiments, the product companies may purchase a one-time license to the services of the system 102.

In some embodiments, the system 102 may be deployed in the environment 100 as an on-premises solution, where the system 102 is implemented and operated locally within the product manufacturing company's infrastructure. In another example, the system 102 may be deployed as a cloud-based solution. In yet another example, the system 102 may be deployed as a hybrid solution, combining on-premises and cloud-based components.

In operation, a user 104 may seek to initiate a recall process of a product. For example, the user 104 may be an employee of a pharmaceutical company and may initiate a recall for a batch of medicines found to contain incorrect labeling or an impurity beyond acceptable limits. In another example, the user 104 may be an employee from a device manufacturing company and may initiate a recall for a medical device discovered to have a manufacturing defect. The user 104 may use a user device 106 for accessing the system 102 to initiate the recall process. Examples of the user device 106 may include, but are not limited to, a smartphone, a laptop, a workstation PC, etc. In said example, the user 104 may login to a user account using the user device 106 and may access the system 102, which may be hosted locally in the environment of the user 104 or may be hosted on a cloud. Subsequently, the user 104 may identify the product and its related batch number which is to be recalled and may provide one or more user inputs related thereto.

In an embodiment, the system 102 may be configured to receive the one or more inputs the user device 106 regarding the recall process for the product. Consequently, the system 102 may be configured to collate the details of the consignees associated with the purchase of the particular batch of the product, generates lists of unique consignees and duplicate consignees, and processes the duplicate consignee list to identify the false duplicate consignees associated with the purchased product.

The unique consignee list may include one or more consignee entries having distinct consignee details. The duplicate consignee list may include one or more entries which have been classified as duplicate entries based on a duplicate determination logic implemented by the system 102. As an example, the consignees whose corresponding consignee details may match partially or exhibit minor discrepancies, such as variations in spelling (e.g., “John Doe” vs. “Jon Doe”), formatting (e.g., “123 Main St” vs. “123 Main Street”), or minor metadata inconsistencies may be classified in the duplicate consignee list. In some examples, where more than one duplicate consignees have been identified, the system 102 may include all the duplicate entries in the duplicate consignee list. In some examples, where more than one duplicate consignees have been identified, the system 102 may include only one of the consignees in the unique consignee list and may include the rest of the consignees in the duplicate consignee list.

In an embodiment, the duplication check technique implemented by the system 102 may be, for example, a fuzzy matching technique to generate lists of unique consignees and duplicate consignees. By implementing the said technique, the system 102 may compare the details of the consignees to generate lists of unique consignees and the duplicate consignees. In an example, the details of the consignees which are used for the aforementioned classification may include first name, last name, and associated email address of the consignees. These details may be obtained by the system 102 from an internal storage or a cloud storage during the stage when the consignee search is performed using the batch number or product details.

Once the unique consignee list and the duplicate consignee list have been prepared, in an embodiment, the system 102 may obtain metadata associated with the consignees included in the duplicate consignee list. This metadata, without limitation, may include a consignee address or a consignee geographical area code or consignee landline number, a consignee type, a consignee billing code, a consignee department-specific identifier, a consignee batch scan information, a consignee telephone contact information, and consignee media updates. Once the metadata is obtained, the system 102 may apply detection rules and algorithms to analyse the duplicate consignee list for identifying falsely deemed duplicate consignees. In an example, when the system 102 is processing the duplicate consignee list, the system 102 may identify that there are two entries with hospital name ABC and same address, however, the sub-department of the hospital ABC where a product was delivered are different. Accordingly, the system 102 may determine that the entries are unique entries and were erroneously classified in the duplicate consignee list. The system 102 may identify the two entries for the hospital ABC as false duplicate consignees.

According to the aspects of the present disclosure, the system 102 may add the falsely identified duplicate consignee back to the recall list, i.e., back to the unique consignee list which is used for sending notifications for recalling the product. This helps in averting a situation where a recall notification was not sent to a consignee owing to the consignee being falsely identified as a duplicate consignee and removed from the recall list. Thus, the efficiency of the recall process is improved.

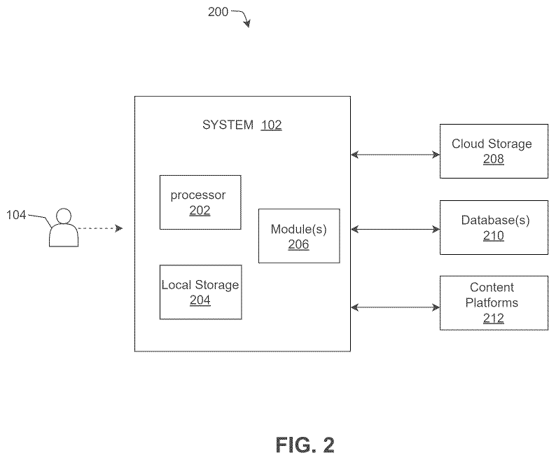

FIG. 2 illustrates a schematic block diagram 200 of the system 102 for the identification of false duplicate consignees in a recall process, according to one or more embodiments of the present subject matter. In some embodiments, the system 102 includes at least one processor 202, a local storage 204, a plurality of modules 206. According to an implementation, the system 102 may be coupled to a cloud storage 208, one or more databases 210, and a content platform 212.

The processor 202, in some examples, may be implemented or realized as general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In some examples, the processor 202 may be realized as microprocessors, controllers, microcontrollers, or state machines. In some examples, the processor 202 may be realized as a combination of computing devices, such as, a combination of digital signal processors and microprocessors, a plurality of microprocessors, one or more microprocessors in conjunction with a digital signal processor core, or any other such combination/configuration. In some embodiments, one or more processors, such as the processor 202 or equivalents thereof, may be provided for performing operations thereof, as described herein.

The local storage 204 comprises one or more non-transitory computer-readable storage media, including but not limited to volatile storage media such as random-access memory (RAM), registers, cache, etc., as well as non-volatile storage media such as read-only memory (ROM), hard disk drives, solid-state drives, flash memory, optical storage devices, and so forth. Furthermore, the local storage 204 may encompass computer-readable storage media that are distributed across a plurality of physical computing devices connected via a network, such as storage clusters within public, private, or hybrid cloud-based environments. In some embodiments, the local storage 204 may be provisioned with software components that facilitate the system 102 in executing functionalities disclosed herein. These software components typically consist of program instructions executable by the processor 202, organized into software applications, virtual machines, software development kits, toolsets, or similar structures. Furthermore, the local storage 204 may be configured to maintain data within one or more databases, file systems, or equivalent data structures. The local storage 204 may also be implemented in other forms and/or configured to store data using alternative methods.

In an example, the local storage 204 may include rules which may be used for determining the veracity of the one or more duplicate consignees present in the second list, based on the metadata associated with each of the said one or more duplicate consignees. Further, local storage 204 may include fuzzy logic or other similar duplication detection logics, which may be used for classifying the main list into a first list and a second list, wherein the first list comprises one or more unique consignees and the second list comprises one or more duplicate consignees from amongst the plurality of consignees. In an example, the rules and the duplication detection logics stored herein may be accessed by the processor 202 and the modules 206, and/or a combination thereof.

In an embodiment, the plurality of modules 206, amongst other things, include routines, programs, objects, components, data structures, etc., which perform particular tasks or implement data types. The module(s) 206 may also be implemented as, signal processor(s), state machine(s), logic circuitries, and/or any other device or component that manipulate signals based on operational instructions.

Further, the module(s) 206 can be implemented in hardware, instructions executed by a processing unit, or by a combination thereof. The processing unit can comprise a computer, a processor, such as the processor 202, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the module(s) 206 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In an embodiment, the module(s) 206 may include a fuzzy logic block. Further, the fuzzy logic block may have an algorithm or set of rules applied to the consignees to classify a plurality of consignees associated with the recall process into a first list and a second list, wherein the first list comprises one or more unique consignees and the second list comprises one or more duplicate consignees from amongst the plurality of consignees. In an embodiment, the fuzzy logic block may be present in the local storage 204 as well. In an embodiment, the module(s) 206 may be coupled to the processor 202.

In an embodiment, the module(s) 206 may include a rule engine (not shown in the figure) which may have access to a list to rules which may applied to metadata associated with the duplicate consignees to determine the veracity of the one or more duplicate consignees during the recall process. The rule engine may select the rule which is to be applied to a duplicate consignee based on the metadata associated with the duplicate consignee. In an embodiment, the metadata may be provided by the processor 204 to the rule engine so that rule engine can select one or more rules based upon said metadata to be applied to said consignee. In an embodiment, the rule engine may create rules based on the metadata associated with consignees. In an embodiment, the list of rules may be present in the local storage 204. In an embodiment, the list to rules may be present in a cloud storage 208. In an embodiment, the rule engine may access the local storage 204 or the cloud storage 208 to retrieve the list to rules to be applied to the metadata associated with the duplicate consignees.

In an embodiment, the cloud storage 208 may serve as a data repository. The cloud storage 210 may consist of various storage mediums, such as network-attached storage (NAS), or cloud storage. The cloud storage 208 may store details of multiple pharmaceutical companies and device manufacturers, their associated consignees, and metadata related to each consignee. The cloud storage 208 may be a centralized repository supporting data retrieval and processing during the recall process.

In an example, the cloud storage 208 may include rules which may be used for determining the veracity of the one or more duplicate consignees present in the second list, based on the metadata associated with each of the said one or more duplicate consignees. Further, the cloud storage 208 may include fuzzy logic or other similar duplication detection logics, which may be used for classifying the main list into a first list and a second list, wherein the first list comprises one or more unique consignees and the second list comprises one or more duplicate consignees from amongst the plurality of consignees. In an example, the rules and the duplication detection logics stored herein may be accessed by the processor 202 and the modules 206, and/or a combination thereof.

Further, the cloud storage 208 may be hosted externally in the cloud environment.

In case where cloud storage 208 hosted externally in a cloud environment, the system 102 connects to the cloud environment via the internet, typically through a web browser or an API. For example, a company with multiple clients and vendors may host the cloud storage 208 on a cloud infrastructure, allowing geographically dispersed users operating different computing devices to access the cloud storage 208 remotely.

In an embodiment, the database(s) 210 may be a Drug Enforcement Administration (DEA) database. For example, the DEA database may be a central system that tracks the legal use and distribution of controlled substances. The DEA database includes includes information such as a catalogue of drugs classified under the Controlled Substances Act (CSA), including both legal and illegal substances, records of entities (e.g., doctors, pharmacies) authorized to handle controlled substances, details about prescriptions for controlled substances, helping monitor misuse, data from investigations into illegal drug activities, etc. In an embodiment, the DEA database may be coupled to the processor 202.

In an embodiment, the database(s) 210 may be a National Provider Identifier (NPI) database. The NPI database may include a comprehensive system used to uniquely identify healthcare providers in the U.S.A. The NPI database may include information such as unique identification numbers assigned to healthcare providers, including doctors, nurses, hospitals, and clinics, information such as the provider's name, practice location, specialty, and contact details, data regarding the professional qualifications and licenses of healthcare providers, etc. In an embodiment, the NPI database may be coupled to the processor 202.

Further, in an embodiment, the system 102 may be coupled to the content platform 212. The content platform 212 may allow discovering content through feeds, trends, or recommendations. The content platform 212 may be used for social interaction, entertainment, business promotion, and information sharing, etc. In an embodiment, the content platform 212 may be accessed by the processor 202 during one or more operations described herein while performing identification of false duplicate consignees in a recall process.

In operation, the system 102 may receive a user input related to the recall of a product from the user 104 (not shown herein). The user input may include information such as a name of the product, a batch number of the product, etc. which may help the system 102 to identify the consignees to which the particular batch of the product was dispatched. For example, the user 104 may provide input instructions specifying the recall details, including the batch number and product type. In an example, the system 102 may present a dropdown menu or list on a display of the user device 106, and the user 104 may select a particular batch or product type that needs to be recalled. In some examples, the system 102 may display a GUI on the user device 106 and the user 104 may manually input the batch number of the product which is to be recalled.

On receiving the user input, the system 102 may be configured to access the local storage 204 and may retrieve the details of a plurality of consignees associated with the recall of the product from the local storage 204. For instance, the processor 202 may be configured to cross-reference the batch number and product type with the stored records to identify the plurality of consignees who received the product from the recalled batch. In an example, the cross-referencing may include verifying product identifiers, like serial numbers or lot codes, against order histories stored at the local storage 204. Further, in an embodiment, the computing device 104 may retrieve the details of the plurality of consignees from the cloud storage 210. For instance, if the recall affects multiple regions, the computing device 104 may access a central cloud repository to obtain consignee details from various geographical locations, including addresses, contact numbers, and order histories. In an embodiment, the computing device 104 may retrieve the details of the consignees from either one of or from both, the local storage 204 and the cloud storage 210. In an example, the details of the consignee may include first name, last name and associate email address of the consignees.

In an embodiment, upon receiving the consignees'details associated with the recall, the processor 202 may be configured to classify the plurality of consignees into a first list and a second list using a duplication check technique, such as fuzzy logic implemented using the fuzzy logic block in the module(s) 206. In an embodiment, the first list may include one or more unique consignees and the second list includes one or more duplicate consignees from amongst the plurality of consignees.

In an example, the unique consignees may refer to individual entities or recipients associated with a recall that appear only once for consignment to be recalled. Each unique consignee represents a distinct recipient, ensuring there is no repetition or overlap with other consignees in terms of first name, second name or the email address. For example, the processor 202 may classify entities like Hospital A, Pharmacy B, and Clinic C as unique consignees. Each of these entities received a single order of the recalled batch of products and appears only once in the dataset. For instance, the processor 202 may evaluate the details for “Hospital A,” such as its name (“Hospital A”) and email (“admin@hospitala.com”). Since these details are distinct and do not overlap with any other records, the processor 202 places Hospital A in the first list of unique consignees. Similarly, “Pharmacy B” and “Clinic C” are categorized as unique because their details, such as first name, last name and email, does not match any other entries in the dataset.

In an example, the duplicate consignees are entities or recipients that appear multiple times in the plurality of consignees associated with the recall. The repetition may occur due to errors of having similar looking first name, second name or entities having same email address. For example, the duplicate consignee list includes a wholesaler X where the wholesaler received the recalled batch on three separate occasions: one for a regional distribution centre, one for a local warehouse, and another for a retail partner but given the same address for every occasion. The wholesaler X appears three times in the dataset. Since the wholesaler X is receiving the same recalled product, the processor 202 may place wholesaler X in the duplicate consignee list.

Post creating the first list and the second list of the consignees, the processor 202 may be configured to obtain metadata associated with the one or more duplicate consignees comprised in the second list. The metadata amongst the other things may include addresses, contact numbers, geographical area code, landline number, social media handles, order histories, department-specific identifier, batch scan information, and product identifiers associated with the recalled batch. In an embodiment, the processor 202 may obtain the metadata from the local storage 204. In an embodiment, the processor 202 may connect to the cloud storage 208 to retrieve the metadata stored therein.

After obtaining the metadata associated with the duplicate consignees included in the second list, the processor 202 may select at least one false duplicate verification rule, from a plurality of false duplicate verification rules, for each of the duplicate consignees to determine the veracity of the duplicate consignee. In order to select the rule for a given consignee in the second list, the processor 202 may provide the metadata associated with the consignee to the rule engine. On receiving the metadata, the rule engine may analyse the metadata to determine the at least one false duplicate verification rule from the plurality of said rules. For instance, the rule engine may identify a false duplicate identification rule with which the maximum number of metadata elements matches and may select said rule. In another example, the rule engine may analyse the information available in the metadata associated with the consignee and may apply one or more internal rules to determine which of the plurality of false duplicate verification rules would be most appropriate for the metadata. For example, if the metadata may include a geographical area code, the rules engine may choose a rule that prioritizes matches based on location proximity. For example, a duplicate consignee with the name “John's Pharmacy,” listed multiple times with metadata such as “123 Main St., Suite 100,” geographical area code “55501,” and billing code “PH1234.” Said metadata may form the basis for applying one or more false duplicate verification rules.

Once the false duplicate verification rule is determined for each of the duplicate consignees included in the second list, the processor 202 may proceed to apply the respective selected at least one false duplicate verification rule on the consignees to determine whether the consignee is falsely included in the second list. Examples explaining the aforementioned operation of the processor 202 are provided below.

In an embodiment, the metadata associated with the one or more duplicate consignees includes consignee type as one of: a doctor and a physician. Herein, for said one or more duplicate consignees, the processor 202 may select at least one false duplicate verification rule based on the consignee type. For example, based on the consignee type, the processor 202 may be configured to query at least one of: a National Provider Identifier (NPI) Database and a Drug Enforcement Administration (DEA) database in the database 210 to determine whether the duplicate consignee is associated with at least two NPIs or at least two DEAs. Further, the processor 202 may be configured to query at least one of: a National Provider Identifier (NPI) Database to determine whether at least two NPIs corresponding to the duplicate consignee exist in the NPI database and a Drug Enforcement Administration (DEA) database to determine whether at least two DEAs identifiers corresponding to the duplicate consignee exist in the DEA database. The processor 202 may be configured to determine whether the at least one NPIs or at least one DEAs of the duplicate consignee is different than at least one NPIs or at least one DEAs of unique consignee corresponding to the duplicate consignee. Further, the processor 202 may perform determining whether an NPI/DEA identifier corresponding to the duplicate consignee is different than an NPI/DEA identifier corresponding to the unique consignee which corresponds to the duplicate consignee when it is determined that at least two NPIs/DEA identifiers exist corresponding to the duplicate consignee. Further, the processor 202 may perform identifying the duplicate consignee as a false duplicate consignee when it is determined that the NPI/DEA identifier corresponding to the duplicate consignee is different than the NPI/DEA identifier corresponding to the unique consignee which corresponds to the duplicate consignee.

For instance, consider a scenario where the second list contains consignees “Dr. John Smith,” initially flagged as duplicates based on their identical names. When the metadata may be retrieved by the processor 202, it indicated that the consignee type for one entry is “doctor,” while for the other entry, it is “physician.” Based on the consignee type metadata, the processor 202 applies the appropriate false duplicate verification rules by checking with the rule engine 206. For both entries, the processor 202 checks the NPI database 214 and the DEA database 212. Upon applying the rule, the processor 202 evaluates that the “doctor” entry for Dr. John Smith is associated with NPI-12345 and DEA-67890 and the “physician” entry for Dr. John Smith is associated with NPI-54321 and DEA-09876. Since each entry has distinct NPI and DEA identifiers, the processor 202 may conclude that these are not true duplicates but instead two unique individuals, despite sharing the same name. In an example, the one or more duplicate consignees

In an embodiment, amongst other things, the metadata associated with the one or more duplicate consignees includes a consignee address or a consignee geographical area code or consignee landline number. Accordingly, for said one or more duplicate consignees, the processor 202 may select at least one false duplicate verification rule based on the consignee address or the consignee geographical area code or the consignee landline number. In an embodiment, the processor 202 may be configured to for each of the one or more duplicate consignees, determine whether a consignee address or a consignee geographical area code or consignee landline number of the duplicate consignee is different than a consignee address or a consignee geographical area code or consignee landline number of a unique consignee corresponding to the duplicate consignee. Further, the processor 202 may be configured to identify the duplicate consignee as a false duplicate consignee when it is determined that the consignee address or a consignee geographical area code or consignee landline number of the duplicate consignee is different than the respective consignee address or a consignee geographical area code or consignee landline number corresponding to the duplicate consignee. In an embodiment, the processor 202 may be configured to obtain the metadata that includes a consignee address or a consignee geographical area code or consignee landline number for the unique consignee corresponding to the duplicate consignee. In an example, the metadata may be obtained from the local storage 204 or the cloud storage 208.

For example, consider a scenario where the metadata associated with duplicate consignees includes consignee address, geographical area code, and landline number. In the second list, two entries for consignees, “John Smith” and “Jonathan Smith,” are flagged as duplicates based on matching first name, last name, and email address (“john. smith@example. com”). The processor 202 then applies a false duplicate verification rule based on the consignee geographical area code to determine their uniqueness. Upon processing, the metadata reveals that one entry has a geographical area code of “3001,” associated with a consignee address in Downtown Springfield, and a landline number 123-456-7890. The other entry has a geographical area code of “4002,” associated with a consignee address in Uptown Springfield, and a landline number 987-654-3210. Since the geographical area codes, addresses, and landline numbers are distinct, the processor 202 may determine that these two entries are false duplicates and represent unique consignees despite sharing the same email address and having similar first and last names.

In an example, the scenario may be possible when a person owns two separate pharmacy stores or inventories at different locations. The orders are made from the same name and email address because the person is the same, but the consignments are placed for different locations. This results in differing addresses and geographical area codes, even though the name and email remain identical.

In an embodiment, the metadata associated with the one or more duplicate consignees may include one or more details, such as a consignee billing code or a consignee department-specific identifier. Herein, for said one or more duplicate consignees, the processor 202 may select at least one false duplicate verification rule based on at least one of the consignee billing code or the consignee department-specific identifier. In an example, the billing code is a unique alphanumeric code assigned to specific services, procedures, or financial transactions within an organization. It is commonly used in healthcare for insurance claims, invoicing, and financial tracking of medical services. Each service or procedure, such as a medical treatment or a diagnostic test, has its own billing code. This ensures that each transaction is correctly recorded and processed for payment, whether it's by insurance companies or direct payments. In an embodiment, the processor 202 may be configured to obtain the metadata that includes a consignee address or a consignee geographical area code or consignee landline number for the unique consignee corresponding to the duplicate consignee. In an example, the metadata may be obtained from the local storage 204 or the cloud storage 208.

In an example, the department-specific identifier is used to differentiate between various departments or units within an organization. It allows the system to assign specific transactions, orders, or services to a relevant department, such as Cardiology, Neurology, or Orthopaedics. These identifiers can be used to track the activities, billing, and resource allocation of each department, ensuring that the right department gets credit for its services.

In an embodiment, the processor 202 may be configured to for each of the one or more duplicate consignees, determine whether at least one of a consignee billing code or a consignee department-specific identifier of the duplicate consignee is different than a consignee billing code or a consignee department-specific identifier of a unique consignee corresponding to the duplicate consignee. Further, the processor 202 may be configured to identify the duplicate consignee as a false duplicate consignee when it is determined that at least one of the consignee billing code or the consignee department-specific identifier of the duplicate consignee is different than the consignee billing code or the consignee department-specific identifier of the unique consignee corresponding to the duplicate consignee.

For example, in a hospital, a patient undergoing a cardiac surgery would be assigned a unique billing code based on the type of surgery. For instance, the surgery might have a code such as “CARDIO123” that identifies the procedure in the hospital's billing system. If another patient undergoes a different procedure, like a routine check-up, they might be assigned a code like “RCUP124.” These codes help ensure that payments are made to the correct department and that the services are billed accurately.

For example, consider a large hospital with multiple departments. A department-specific identifier could be something like “CARDIO01” for the Cardiology department, “NEURO02” for the Neurology department, or “ORTHO03” for Orthopaedics. If a patient from the Cardiology department orders medical supplies, the system 102 will tag the order with the department-specific identifier “CARDIO01,” linking it to the Cardiology department. This identifier helps manage inventory, track department budgets, and ensure that each department's transactions are separately recorded and handled.

For example, consider a scenario where the second list of consignees includes “John Doe,” flagged as a duplicate due to a similar name. The metadata for these entries includes a consignee billing code and a department-specific identifier. For one entry, the billing code is “MED123” and the department identifier is “CARDIO01,” while for the other entry, the billing code is “MED124” and the department identifier is “ORTHO02.” Upon processing, the processor 202 finds that the billing codes and department identifiers differ, indicating that these consignees are associated with different departments (Cardiology and Orthopedics), despite sharing the same name. As a result, the processor 202 identifies this as a false duplicate, ensuring that the consignees are treated as distinct entities.

In an embodiment, the metadata associated with the one or more duplicate consignees comprises consignee batch scan information. The consignee batch scan information comprises information about one or more geographic locations where one or more historic batches of consignments were scanned. In an embodiment, for said one or more duplicate consignees, the processor 202 may select at least one false duplicate verification rule is based on the consignee batch scan information. In an embodiment, the processor 202 may be configured to for each of the one or more duplicate consignees, determine whether the consignee batch scan information is different than a consignee batch scan information of a unique consignee corresponding to the duplicate consignee. Further, the processor 202 may be configured to identify the duplicate consignee as a false duplicate consignee when it is determined that the consignee batch scan information of the duplicate consignee is different than the consignee batch scan information of the unique consignee corresponding to the duplicate consignee. In an embodiment, the processor 202 may be configured to obtain the metadata that includes consignee batch scan information for the unique consignee corresponding to the duplicate consignee. In an example, the metadata may be obtained from the local storage 204 or the cloud storage 208.

In an example, in a consignment management system, each consignment is assigned a unique identifier, such as a barcode or QR code, which is scanned during various stages of the consignment process. The scanning equipment records metadata, including the geographic location of the scan, and stores this information in the consignment's metadata. In an example, the scanning equipment may be placed at strategic points within the consignment process, such as warehouses, distribution centers, or retail locations. At each scanning point, the equipment captures the consignment's unique identifier and records the geographic location of the scan, along with a timestamp. Said metadata may be stored in the local storage 204 against the metadata associated with any consignment. Further, in an embodiment, the metadata may be stored in the cloud storage 210 corresponding to the associated one or more consignees.

For example, consider a scenario where two consignees, “John Doe” and “Jane Doe,” are flagged as duplicates due to matching names and email addresses. Upon retrieving metadata, the processor 202 upon running the rule associated with the consignee batch scan information may evaluate that the consignee batch scan information for “John Doe” indicates consignments were scanned in New York and Los Angeles, while “Jane Doe” has consignments scanned in Chicago and Miami. Since the batch scan information differs, the processor 202 concludes that these are false duplicates and are two unique consignees despite sharing similar names and email addresses.

In an embodiment, the metadata associated with the one or more duplicate consignees may include consignee media information. The consignee media information may include consignee name change update or consignee merger and acquisition update. In an example, the consignee media information may be at least one of the social media handles of the consignees, newsletters, press release information, Industry Publications, etc. In an embodiment, for said one or more duplicate consignees, the processor 202 may select at least one false duplicate verification rule based on the consignee media information. In an embodiment, the processor 202 may be configured to determine the consignee's name or consignee merger and acquisition's update for a unique consignee corresponding to the duplicate consignee. Further, the processor 202 may be configured to identify the duplicate consignee as a false duplicate consignee when it is determined that the consignee's name or consignee merger and acquisition's update are different for the unique consignee corresponding to the duplicate consignee.

For example, if a consignee undergoes a rebranding or legal name change, media outlets or official announcements may report this change. For instance, a pharmaceutical company named “ABC Pharmaceuticals” might rebrand as “ABC Pharma Inc.” Such updates are typically disseminated through press releases, news articles, or official company communications. Further, in an example, when a consignee merges with or acquires another company, this information is often shared through corporate press releases, industry news platforms, or financial news outlets. For example, if “XYZ Pharmaceuticals” merges with “LMN Pharmaceuticals,” the merger details would be reported in business news sections and on the companies' official websites.

Consider a scenario where two hospitals, “St. Mary's Medical Center” and “St. Mary's Hospital,” are flagged as duplicates due to their similar names and have a common contact person who uses a single email address for correspondence. Further, processor 202 retrieves consignee media information, which includes updates from content platform 212. The processor 202 may identify that “St. Mary's Medical Center” and “St. Mary's Hospital,” are distinct hospitals, each with its own operations and different location. The shared email address is due to a common contact person who manages communications for both companies. The processor 202 then applies the false duplicate verification rule, considering the social media updates that confirm the hospitals'distinct identities. The processor 202 then determines that they refer to separate entities and false duplicate consignees.

In yet another scenario, two pharmaceutical companies, “ABC Pharmaceuticals” and “ABC_{X} Pharmaceuticals,” are flagged as duplicates because they share the same email address and have similar names. When the processor 202 applies the false duplicate verification rule related to the consignee media information, retrieves consignee media information, which includes updates from content platform 212, the processor 202 identifies that “ABC Pharmaceuticals” underwent a merger with “LMN Pharmaceuticals” to form a new entity, “ABC-LMN Pharmaceuticals,” as announced on the consignee's official social media channels. This merger update is reflected in the consignee media information. It compares the consignee names and determines that, “ABC-LMN Pharmaceuticals” is now refers to the new company Therefore, the processor 202 identifies the ABC Pharmaceuticals as a false duplicate consignee.

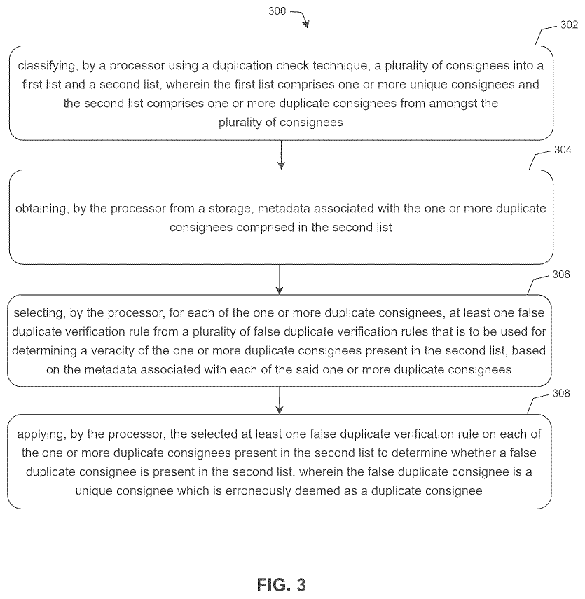

FIG. 3 illustrates a flowchart of a method 300 for identification of false duplicate consignees in a recall process, according to one or more embodiments of the present disclosure. In an example, the recall process may be performed in various industries, such as, but not limited to, automotive, consumer electronics, food and beverage, medicines, medical devices, etc. The steps of the method 300, described in connection with the embodiments disclosed herein, may be embodied directly in hardware, in firmware, in a software module executed by a system, or in any practical combination thereof. In some embodiments, the method 300 may be implemented by the system 102 which may be deployed locally within the product manufacturing company's infrastructure or may be deployed as a cloud-based solution to facilitate the recall of a product for said product manufacturing company.

In an example, the method 300 may commence when the product manufacturing company initiates a recall process. The initiation involves the system 102 receiving a request from a user who may be an employee of the product manufacturing company, say a pharmaceutical company. Herein, the user may initiate a recall for a batch of medicines found to contain incorrect labeling or an impurity beyond acceptable limits. In another example, the user may be an employee from a device manufacturing company and may initiate a recall for a medical device discovered to have a manufacturing defect. The user may use a user device to initiate the recall process. The user may login to a user account using the user device and may access the system 102. Subsequently, the user may identify the product and its related batch number which is to be recalled and may provide one or more user inputs related thereto.

At step 302, the method 300 includes classifying a plurality of consignees into a first list and a second list using a duplication check technique. As mentioned above, the user of the product manufacturing company may initiate the recall process for the product using the user device. Once the user provides the user input which includes the details of the product and/or the batch number, the plurality of consignees to which the product was shipped is retrieved from the storage. In an example, the plurality of consignees associated with the recall process may be retrieved from various storage options, including a local storage 204 or a cloud storage 208. Thereafter, in the present step, the plurality of consignees is classified into the first list and the second list using the duplication check technique. In one embodiment, the first list comprises one or more unique consignees, while the second list comprises one or more duplicate consignees identified among the plurality of consignees. The duplication check technique may be executed using the module(s) 206 in the system 102. In an example, the step 302 may be performed by the processor 202. A detailed description of the present step 302 is provided below.

Upon receiving the recall request, the plurality of consignees associated with the product recall is retrieved. In an embodiment, the plurality of consignees may be stored in either local storage 204 or cloud storage 208. The data associated with the plurality of consignees may typically consists of fields such as the consignee's first name, second name, and the email address. To facilitate classification, the duplication check technique may be applied to the plurality of consignee. In an example, the duplication check technique may use advanced algorithms, such as string matching, fuzzy matching, or unique identifier comparisons, to analyse and compare the plurality of consignees for overlaps or similarities. In an embodiment, the duplication check technique may evaluate each consignee record to identify potential duplicates based on similarities in one or more fields. For example, if two consignees share the same first and second names, the duplication check technique may classify them as potential duplicates. Said consignees may be included in the second list. Conversely, consignees that do not exhibit similarities with any other records are classified as unique and included in the first list.

In an example, the second list may include one or more duplicate consignees identified among the plurality of consignees. In some examples, where more than one duplicate consignee has been identified, all the duplicate entries may be included in the duplicate consignee list. Further, in an example, where more than one duplicate consignee has been identified, one of the consignees may be kept in the unique consignee list and the other consignees may be included in the duplicate consignee list. In another example, where one duplicate consignee has been identified, one consignee may be included in the unique consignee list and the other may be included in the duplicate consignee list. Further, in an example, where one or more than one duplicate consignee has been identified, all the consignees may be included in the duplicate consignee list.

At step 304, the method 300 includes obtaining metadata associated with the one or more duplicate consignees comprised in the second list. The metadata amongst the other things may include addresses, contact numbers, geographical area code, landline number, social media handles, order histories, department-specific identifier, batch scan information, and product identifiers associated with the recalled batch. In an example, the metadata may help in verifying whether the consignees in the second list are actual duplicates or false duplicates. In an example, the metadata may be retrieved from various storage options, such as the local storage 204 and/or a cloud storage 208. The step 304 may be performed by the processor 202, in an example.

At step 306, the method 300 includes selecting, for each of the one or more duplicate consignees, at least one false duplicate verification rule from a plurality of false duplicate verification rules that is to be used for determining a veracity of the one or more duplicate consignees present in the second list. In an example, a false duplicate consignee refers to a unique consignee that has been erroneously classified as a duplicate due to similarities in metadata fields, but after applying the verification rules, it is determined that the consignee is not actually a duplicate consignee. In an embodiment, at least one false duplicate verification rule may be selected based on the metadata associated with each of the said one or more duplicate consignees. In an example, the metadata may provide information for various fields for each duplicate consignee in the second list. These fields may be address, contact details, billing codes, or department-specific identifiers and the information included in these fields for a duplicate consignee which is being processed may be used to evaluate which verification rule or combination of verification rules may be most suitable for verifying the duplicate consignee.

As mentioned above, in an example, a rule or combination of rules to be applied to the duplicate consignee may depend on the number and type of metadata fields available for said consignees. If multiple metadata fields are available for a duplicate consignee, more than one rule may be selected which may be applicable for said each of the fields. For example, if the metadata contains multiple fields like Name, Billing Code, and Contact Number, and multiple rules were selected (e.g., Billing Code Rule, and Contact Number Rule), each or some of the rules which correspond to the aforementioned metadata may be applied to the consignee. For instance, if the names are similar for the two duplicate consignees but the contact numbers and addresses differ, then the Contact Number Rule may be applied to confirm whether the contact numbers belong to the same consignee. The method 300 may include retrieving the at least one false duplicate verification rule from the module(s) 206 and/or from the storages described above. The step may be performed by the processor 202 in the system 102.

At step 308, for each of the one or more duplicate consignees present in the second list the corresponding selected at least one false duplicate verification rule is applied thereto to determine whether a false duplicate consignee is present in the second list. The step may be performed by the processor 202 in the system 102.

In an example, if the second list contains a record for two consignees with the same name, “John Smith,” the system 102 may obtain metadata such as their respective addresses, geographical area codes, and telephone contact information. The metadata retrieved for the first “John Smith”” may include an address in California, while the metadata for the second “John Smith” indicates an address in New York. Similarly, one record may include a department-specific identifier “Pharma_001,” while the other includes “Pharma_002,” suggesting that they belong to different departments.

The metadata may be analysed to identify discrepancies or similarities among the fields of the metadata. For example, if two consignees have identical addresses and contact numbers, the method 300 may classify them as actual duplicates. Further, if the addresses are indeed distinct, or if additional metadata such as department-specific identifiers or billing codes do not match, the method 300 may classify them as false duplicates and reassign the record to the first list.

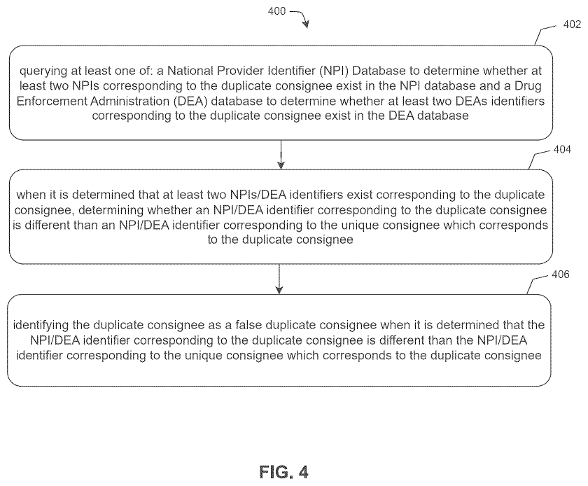

FIG. 4 is a flowchart illustrating a method 400 for determining a veracity of one or more duplicate consignees which are classified in a duplicate consignee list in a recall process, according to one or more embodiments of the present disclosure. In an embodiment, the metadata associated with some or all of the consignees included in the second list may indicate a type of the consignee as being one of a doctor or a physician. Accordingly, for such consignees at least one false duplicate verification rule which is based on a type of the consignee may be selected for determining whether the consignee was rightly classified in the second list or not. In an example, the processor 202 may select the at least one rule based on the consignee type from a plurality of verification rules stored in the module(s) 206 and/or the different storages described above.

As mentioned above, once the consignees for which consignee type information is available in the metadata are identified, the selected verification rule which is based on consignee type may be applied to each of such consignees to determine whether these consignees were rightly classified in the second list or not. For ease of explanation, the below steps of method 400 are explained with reference to a single duplicate consignee for which the consignee type metadata is available and for which the verification rule based on consignee type has been selected.

To this end, at step 402, one or more of a National Provider Identifier (NPI) Database and a Drug Enforcement Administration (DEA) database may be queried. The NPI database may be queried to determine whether at least two NPIs corresponding to the duplicate consignee exist in the NPI database or not. The DEA database may be queried to determine whether at least two DEAs identifiers corresponding to the duplicate consignee exist in the DEA database or not.

At step 404, when it is determined that at least two NPIs/DEA identifiers exist corresponding to the duplicate consignee, it is determined whether an NPI/DEA identifier corresponding to the duplicate consignee is different than an NPI/DEA identifier corresponding to the unique consignee which corresponds to the duplicate consignee.

At step 406, the duplicate consignee is identified as a false duplicate consignee when it is determined that the NPI/DEA identifier corresponding to the duplicate consignee is different than the NPI/DEA identifier corresponding to the unique consignee which corresponds to the duplicate consignee.

For example, once consignees are flagged as duplicates due to having similar personal information, the method 400 retrieves their professional metadata, such as NPIs or DEAs. The method 400 then queries relevant databases, such as the NPI Database and the DEA Database, to check if the duplicate consignee is associated with multiple NPIs or DEAs. At the same time, the method 400 may query said databases to determine whether the unique consignee, corresponding to the duplicate, may be linked to one or more NPIs or DEAs. If the duplicate consignee is found to have different NPIs or DEAs compared to the unique consignee, the method 400 may identify the consignees as distinct individuals practicing under different professional licenses or in different locations. In an example, the method 400 may use algorithms to cross-check the NPI and DEA numbers for each consignee and compares them with the numbers associated with the unique consignee. If the duplicate consignee is associated with different NPIs or DEAs than the unique consignee, the method 400 suggests that the duplicate entries might refer to different individuals, and identify them as false duplicates.

For example, Dr. John Smith, flagged as a duplicate consignee, is found in the NPI Database with two NPIs, one associated with his practice in New York and another linked to a different clinic in California. The method also retrieves the professional metadata of the unique consignee linked to the duplicate, say Dr. Jonathan Smith. If Dr. Jonathan Smith only has one NPI associated with a clinic in Chicago, the method 400 identifies that Dr. John Smith and Dr. Jonathan Smith may not be the same person. Since the duplicate consignee is associated with different NPIs than the unique consignee, the method may consider the duplicate consignee as a false duplicate and update the first list and the second list accordingly.

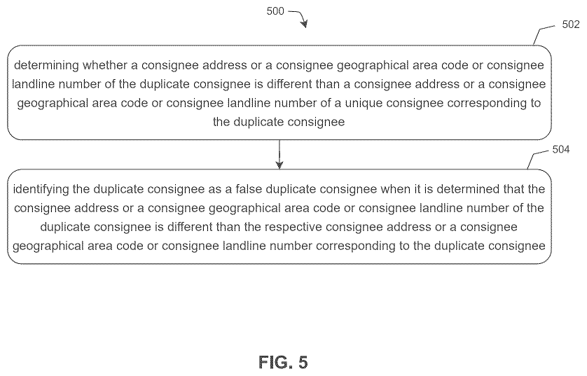

FIG. 5 is a flowchart illustrating a method 500 for determining a veracity of one or more duplicate consignees which are classified in a duplicate consignee list in a recall process, according to one or more embodiments of the present disclosure. In an embodiment, the at least one false duplicate verification rule may be selected based upon the metadata comprising a consignee address or a consignee geographical area code or consignee landline number. The selected at least one false duplicate verification rule is based on the consignee geographical area code. The method 500 may retrieve at least one false duplicate verification rule is based on the consignee type from the module (s)206 and/or the storage. The step may be performed by the processor 202. Further, in an embodiment, the at least one false duplicate verification rule based on the consignee geographical area code may be applied for each of the one or more duplicate consignees which has the metadata comprising consignee address or the consignee geographical area code or the consignee landline number.

At step 502, the method 500 may determine whether a consignee address or a consignee geographical area code or consignee landline number of the duplicate consignee is different than a consignee address or a consignee geographical area code or consignee landline number of a unique consignee corresponding to the duplicate consignee. In an example, the method 500 may determine whether the physical location of the consignee differs between the duplicate consignee from the unique consignee corresponding to the duplicate consignee. Further, in an example, the method 500 may determine the differences in the area codes associated with the duplicate consignee from the unique consignee corresponding to the duplicate consignee, which may indicate that they are located in distinct regions. Further, in an example, the method 500 may determine the differences in the landline numbers associated with the duplicate consignee and the unique consignee corresponding to the duplicate consignee. Said step involves comparing the metadata fields of both the duplicate consignee and the unique consignee corresponding to the duplicate consignee. In an example, the relevant metadata for the unique consignee corresponding to the duplicate consignee, which includes the consignee address or the consignee geographical area code or the consignee landline number may be retrieved from the local storage 204 or the cloud storage 208.

At step 504, the method 500 may identify the duplicate consignee as a false duplicate consignee when it is determined that the consignee address or a consignee geographical area code or consignee landline number of the duplicate consignee is different than the respective consignee address or a consignee geographical area code or consignee landline number corresponding to the duplicate consignee. Once the differences are identified, the method 500 may update the status of said duplicate consignee to indicate that it is a false duplicate and update the first list and second list accordingly.

For example, a duplicate consignee, “John Smith,” has a geographical area code of “310”, typically associated with California, but the corresponding unique consignee, also named “John Smith,” has a geographical area code of 212, typically associated with New York. The method 500 may identify them as false duplicates. The difference in area codes suggests that the consignees are likely located in different regions of the country, and hence not be classified as duplicates. Further, in an example, if the addresses for the duplicate and unique consignees differ, such as one consignee being listed at “123 Main Street, Los Angeles, CA” and the unique consignee corresponding to the duplicate consignee at “456 Elm Street, New York, NY, the method 500 may identify the entries as false duplicates.

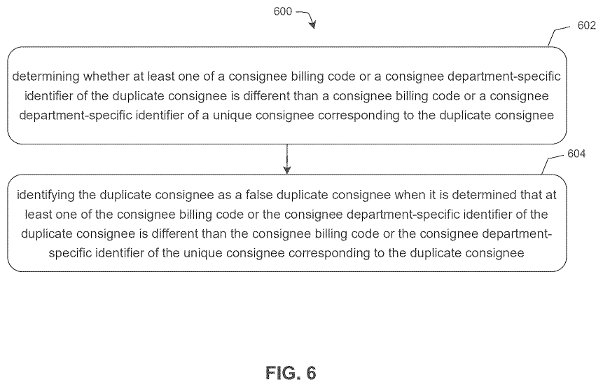

FIG. 6 is a flowchart illustrating a method 600 for determining a veracity of one or more duplicate consignees which are classified in a duplicate consignee list in a recall process, according to one or more embodiments of the present disclosure. In an embodiment, the at least one false duplicate verification rule may be selected based upon the metadata comprising at least one of: a consignee billing code or a consignee department-specific identifier. The selected at least one false duplicate verification rule is based on the at least one of: the consignee billing code or the consignee department-specific identifier. The method 600 may retrieve at least one false duplicate verification rule is based on at least one of: a consignee billing code or a consignee department-specific identifier from the module(s) 206 in the system 102. The step may be performed by the processor 202 in the system 102. Further, in an embodiment, the at least one false duplicate verification rule based on the at least one of: the consignee billing code or the consignee department-specific identifier may be applied to for each of the one or more duplicate consignees which has the metadata comprising at least one of: the consignee billing code or the consignee department-specific identifier.

At step 602, the method 600 may determine whether at least one of a consignee billing code or a consignee department-specific identifier of the duplicate consignee is different than a consignee billing code or a consignee department-specific identifier of a unique consignee corresponding to the duplicate consignee. In said step, the metadata fields, specifically the billing code and department-specific identifier, between the duplicate consignee and the unique consignee is compared. In an example, the relevant metadata for the unique consignee corresponding to the duplicate consignee, which includes the consignee billing code and department-specific identifier may be retrieved from the local storage 204 or the cloud storage 208. The method 600 may then checks if either of these fields differs between the two records.

At step 604, the method 600 may identify the duplicate consignee as a false duplicate consignee when it is determined that at least one of the consignee billing code or the consignee department-specific identifier of the duplicate consignee is different than the consignee billing code or the consignee department-specific identifier of the unique consignee corresponding to the duplicate consignee. Based on the comparison in step 602, if a difference is found in either the consignee billing code or the department-specific identifier, the method 600 may identify the duplicate consignee as a false duplicate and update the first list and the second list accordingly.

For example, if the duplicate consignee has a billing code of “B1234” and a department-specific identifier of “Pharma_001,” but the unique consignee corresponding to the duplicate consignee has a billing code of “B5678” and a department-specific identifier of “Pharma_002,” the method may identify a mismatch in both the billing code and the department-specific identifier. This may indicate that the consignees are not duplicates, even if other details, such as name and email address, may have appeared similar.

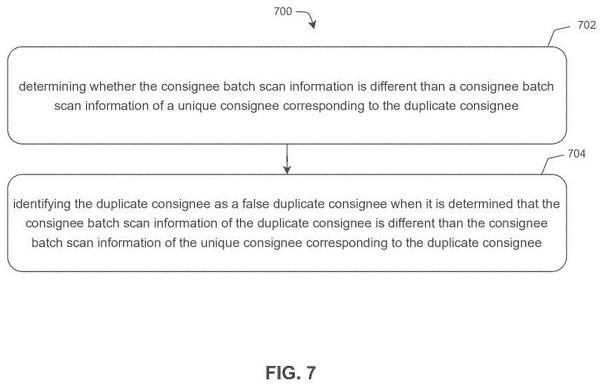

FIG. 7 is a flowchart illustrating a method 700 for determining a veracity of one or more duplicate consignees which are classified in a duplicate consignee list in a recall process, according to one or more embodiments of the present disclosure. In an embodiment, the at least one false duplicate verification rule may be selected based upon the metadata comprising consignee batch scan information. The selected at least one false duplicate verification rule is based on the information about one or more geographic locations where one or more historic batches of consignments were scanned. The method 400 may retrieve at least one false duplicate verification rule is based on the consignee batch scan information from the module (s) 206 in the system 102. The step may be performed by the processor 202 in the system 102. Further, in an embodiment, the at least one false duplicate verification rule based on the consignee batch scan information may be applied to for each of the one or more duplicate consignees which has the metadata comprising consignee batch scan information.

At step 702, the method 700 may include determining whether the consignee batch scan information is different than a consignee batch scan information of a unique consignee corresponding to the duplicate consignee. In an example, to implement the step, the method 700 may compare the batch scan information associated with the duplicate consignee to that of the unique consignee. In an example, the consignee batch scan information comprises information about one or more geographic locations where one or more historic batches of consignments were scanned. In an example, the relevant metadata for the unique consignee corresponding to the duplicate consignee, which includes the batch scan information may be retrieved from the local storage 204 or the cloud storage 208. For example, if the duplicate consignee has batch scan information that shows consignments were scanned in a warehouse in Chicago, but the corresponding unique consignee's batch scan information indicates consignments were scanned in a warehouse in Los Angeles, this may indicate that the two consignees are false duplicates.

At step 704, the method 700 may identify the duplicate consignee as a false duplicate consignee when it is determined that the consignee batch scan information of the duplicate consignee is different than the consignee batch scan information of the unique consignee corresponding to the duplicate consignee. If the batch scan information of the duplicate consignee is found to be different from that of the unique consignee corresponding to the duplicate consignee, the method 704 may identify the duplicate consignee as a false duplicate and update the first list and the second list accordingly.

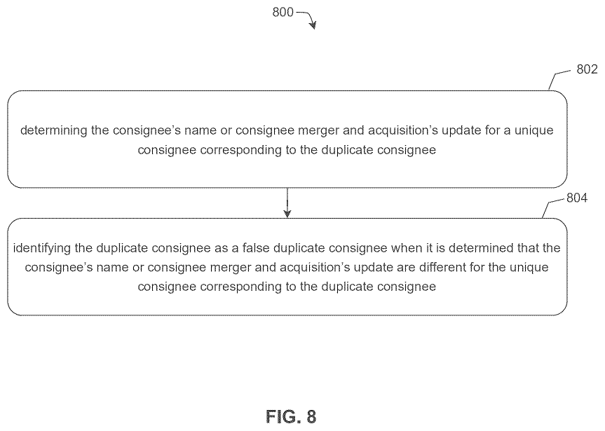

FIG. 8 is a flowchart illustrating a method 800 for determining a veracity of one or more duplicate consignees which are classified in a duplicate consignee list in a recall process, according to one or more embodiments of the present disclosure. In an embodiment, the at least one false duplicate verification rule may be selected based upon the metadata comprising consignee media information. The selected at least one false duplicate verification rule is based on the consignee media information comprises consignee name change update or consignee merger and acquisition update. The method 400 may retrieve at least one false duplicate verification rule is based on the consignee media information from the module(s) 206 in the system 102. The step may be performed by the processor 202 in the system 102. Further, in an embodiment, the at least one false duplicate verification rule based on the consignee media information may be applied to for each of the one or more duplicate consignees which has the metadata comprising consignee name change update or consignee merger and acquisition update.

At step 802, the method 800 may include determining the consignee's name or consignee merger and acquisition's update for a unique consignee corresponding to the duplicate consignee. In said step, the method 800 may compare the consignee media information of the duplicate consignee with the information associated with the unique consignee to detect if any updates, such as name changes or mergers, exist. In an example, the consignee media information may be at least one of the social media handles of the consignees, newsletters, press release information, Industry Publications, etc. In an example, the relevant metadata for the unique consignee corresponding to the duplicate consignee, which includes t the consignee's name or consignee merger and acquisition's update may be retrieved from the content platform 212.

At step 804, the method 800 may identify the duplicate consignee as a false duplicate consignee when it is determined that the consignee's name or consignee merger and acquisition's update are different for the unique consignee corresponding to the duplicate consignee.

Consider a scenario where two hospitals, “St. Mary's Medical Center” and “St. Mary's Hospital,” are flagged as duplicates due to their similar names and have a common contact person who uses a single email address for correspondence. Further, when the consignee media information, which includes updates from content platform 212 may be retrieved, the method 800 may identify that “St. Mary's Medical Center” and “St. Mary's Hospital,” are distinct hospitals, each with its own operations and different location. The shared email address is due to a common contact person who manages communications for both companies. Upon applying the false duplicate verification rule, considering the social media updates that confirm the hospitals'distinct identities, the method 800 may identify that they refer to separate entities and false duplicate consignees.

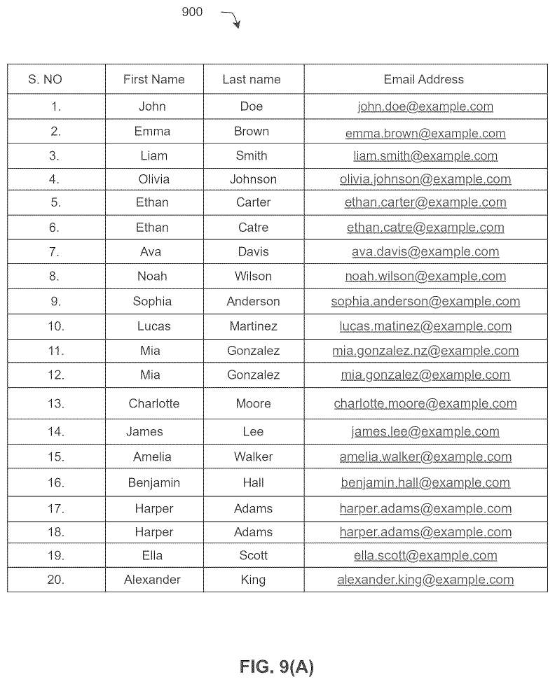

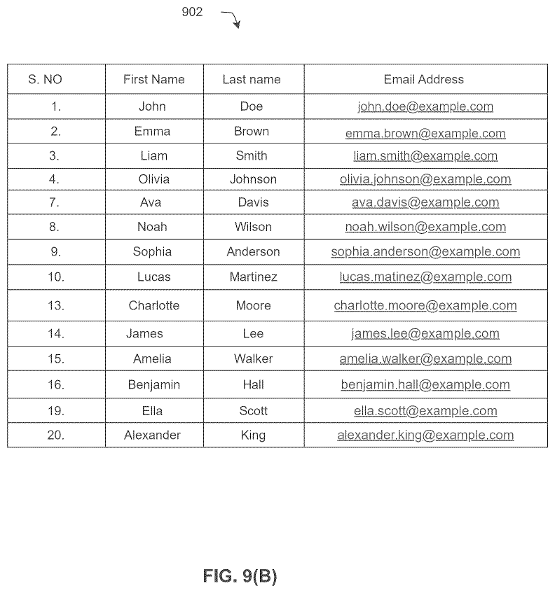

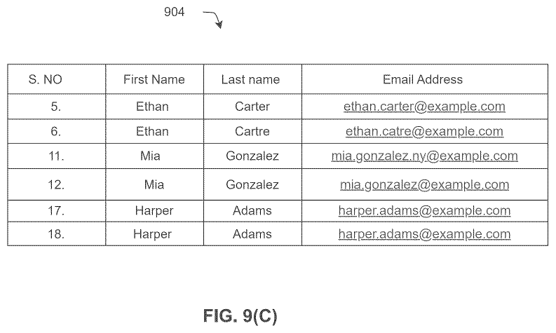

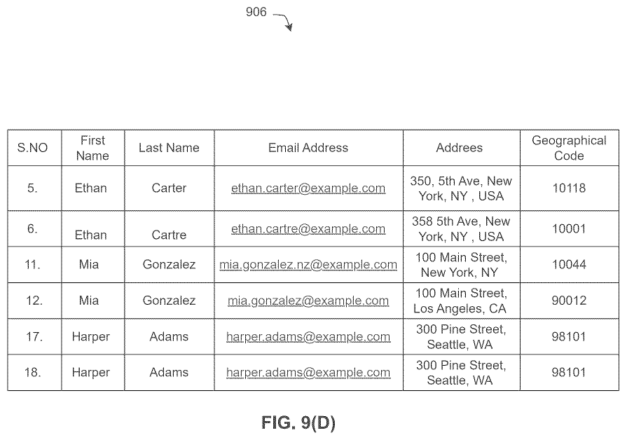

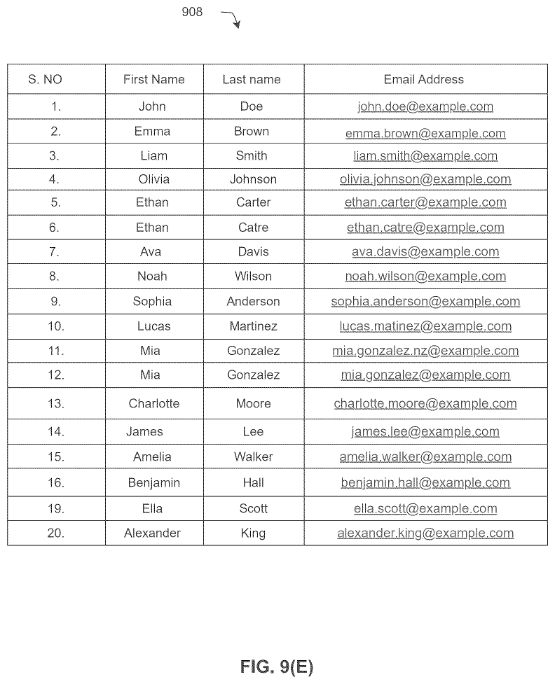

FIG. 9A-9E illustrates use cases 900 (A-E) depicting implementations of the system 102, according to some embodiments of the present disclosure. FIG. 9A illustrates a list of consignees 900 associated with the recall process. In an example, the list comprises 20 consignees along with their details including first name, last name, and associated email address of the each of the 20 consignees. These details may be obtained by the system 102 from an internal storage or a cloud storage during the stage when the consignee search is performed using the batch number or product details. Once the list of the consignees associated with the recall process is obtained, said list is further divided into a first list and a second list wherein the first list includes unique consignees and the second list includes duplicate consignees. Said first list and the second list may be created by applying duplication detection technique on obtained list of consignees. The duplication detection technique may use the details associated with the consignees in the list to create said first list and the second list.

In the use case illustrated in 9B, the list 902 may indicate the first list comprising a total of 14 consignees out of 20 consignees which are identified as unique using the duplication detection technique. Further, in the case illustrated in 9C, the list 904 may indicate the second list comprising a total of 6 consignees out of 20 consignees which are identified as duplicate consignees using the duplication detection technique. The duplication detection technique may compare details of each of the consignees with rest of the other consignees to creates said lists.

Post creating the first list and the second list depicted in 902 and 904, metadata corresponding to consignees in the second list may be obtained. The metadata includes address and the geographical code for said consignees. Accordingly, the processor 202 may select one false duplicate verification rule for determining a veracity of the one or more duplicate consignees present in the second list, based on the address and the geographical code for said consignees associated with each of the said one or more duplicate consignees in the second list 904.

In the use case illustrated in 9D, the list 906 may indicate the details of six identified duplicate consignees along with their details and the metadata. Said list 906 may be applied with false duplicate verification rule to identify whether more one or more duplicate consignees present in the second list are false duplicates or true duplicates. When the false duplicate verification rule is applied, it was observed that address and code for Ethan Carter and Ethan Cartre is different though they appear to same due to similar looking first name, last name and the email address. Said duplicate entries may be identified as false duplicates. Further, for the entry of Mia Gonzalez, it was observed that address and code for both the Mia Gonzalez at 11 and 12 number in the list are different though they appear to same due to similar looking first name, last name and the email address. Said duplicate entries may be identified as false duplicates. Further, for the entry of Harper Adams, it was observed that address and code for both the Harper Adams at 17 and 18 number in the list are same and also, they appear to same due to similar looking first name, last name and the email address. Said duplicate entries may be identified as true duplicates.

In the use case illustrated in 9E, the list 908 depicts the revised first list including the unique consignees. Said list has been updated by the processor and includes the entries which were identified as false duplicates. Said list now includes the entries corresponding to Mia Gonzalez, Mia Gonzalez, Ethan Carter and Ethan Cartre.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for identification of false duplicate consignees in a recall process, the method comprising:
classifying, by a processor (202) using a duplication check technique, a plurality of consignees into a first list and a second list, wherein the first list comprises one or more unique consignees and the second list comprises one or more duplicate consignees from amongst the plurality of consignees;
obtaining, by the processor (202) from a storage, metadata associated with the one or more duplicate consignees comprised in the second list;
selecting, by the processor (202), for each of the one or more duplicate consignees, at least one false duplicate verification rule from a plurality of false duplicate verification rules that is to be used for determining a veracity of the one or more duplicate consignees present in the second list, based on the metadata associated with each of the said one or more duplicate consignees; and
applying, by the processor (202), the selected at least one false duplicate verification rule on each of the one or more duplicate consignees present in the second list to determine whether a false duplicate consignee is present in the second list, wherein the false duplicate consignee is a unique consignee which is erroneously deemed as a duplicate consignee.

2. The method of claim 1, wherein the metadata associated with the one or more duplicate consignees comprises at least one of: a consignee address or a consignee geographical area code or consignee landline number, a consignee type, a consignee billing code, a consignee department-specific identifier, a consignee batch scan information, a consignee telephone contact information, and consignee media updates.

3. The method of claim 2, wherein the metadata associated with the one or more duplicate consignees comprises consignee type as one of: a doctor and a physician, wherein the selected at least one false duplicate verification rule is based on the consignee type, and wherein the applying further comprises:
for each of the one or more duplicate consignees:
querying at least one of: a National Provider Identifier (NPI) Database to determine whether at least two NPIs corresponding to the duplicate consignee exist in the NPI database and a Drug Enforcement Administration (DEA) database to determine whether at least two DEAs identifiers corresponding to the duplicate consignee exist in the DEA database;
when it is determined that at least two NPIs/DEA identifiers exist corresponding to the duplicate consignee, determining whether an NPI/DEA identifier corresponding to the duplicate consignee is different than an NPI/DEA identifier corresponding to the unique consignee which corresponds to the duplicate consignee; and
identifying the duplicate consignee as a false duplicate consignee when it is determined that the NPI/DEA identifier corresponding to the duplicate consignee is different than the NPI/DEA identifier corresponding to the unique consignee which corresponds to the duplicate consignee.

4. The method of claim 2, wherein the metadata associated with the one or more duplicate consignees comprises a consignee address or a consignee geographical area code or consignee landline number, wherein the selected at least one false duplicate verification rule is based on the consignee consignee address or the consignee geographical area code or the consignee landline number, and wherein the applying further comprises:
for each of the one or more duplicate consignees:
determining whether a consignee address or a consignee geographical area code or consignee landline number of the duplicate consignee is different than a consignee address or a consignee geographical area code or consignee landline number of a unique consignee corresponding to the duplicate consignee; and
identifying the duplicate consignee as a false duplicate consignee when it is determined that the consignee address or a consignee geographical area code or consignee landline number of the duplicate consignee is different than the respective consignee address or a consignee geographical area code or consignee landline number corresponding to the duplicate consignee.

5. The method of claim 2, wherein the metadata associated with the one or more duplicate consignees comprises at least one of: a consignee billing code or a consignee department-specific identifier, wherein the selected at least one false duplicate verification rule is based on at least one of: the consignee billing code or the consignee department-specific identifier, and wherein the applying further comprises:
for each of the one or more duplicate consignees:
determining whether at least one of a consignee billing code or a consignee department-specific identifier of the duplicate consignee is different than a consignee billing code or a consignee department-specific identifier of a unique consignee corresponding to the duplicate consignee; and
identifying the duplicate consignee as a false duplicate consignee when it is determined that at least one of the consignee billing code or the consignee department-specific identifier of the duplicate consignee is different than the consignee billing code or the consignee department-specific identifier of the unique consignee corresponding to the duplicate consignee.

6. The method of claim 1, wherein the metadata associated with the one or more duplicate consignees comprises consignee batch scan information, wherein the consignee batch scan information comprises information about one or more geographic locations where one or more historic batches of consignments were scanned, wherein the selected at least one false duplicate verification rule is based on the consignee batch scan information, and wherein the applying further comprises:
for each of the one or more duplicate consignees:
determining whether the consignee batch scan information is different than a consignee batch scan information of a unique consignee corresponding to the duplicate consignee; and
identifying the duplicate consignee as a false duplicate consignee when it is determined that the consignee batch scan information of the duplicate consignee is different than the consignee batch scan information of the unique consignee corresponding to the duplicate consignee.

7. The method of claim 1, wherein the metadata associated with the one or more duplicate consignees comprises consignee media information, wherein the consignee media information comprises consignee name change update or consignee merger and acquisition update, wherein the selected at least one false duplicate verification rule is based on the consignee media information, and wherein the applying further comprises:
for each of the one or more duplicate consignees:
determining the consignee's name or consignee merger and acquisition's update for a unique consignee corresponding to the duplicate consignee; and
identifying the duplicate consignee as a false duplicate consignee when it is determined that the consignee's name or consignee merger and acquisition's update are different for the unique consignee corresponding to the duplicate consignee.

8. A system for identification of false duplicate consignees in a recall process, the system comprising:
a storage;
a processor provided in at least a computing device, wherein the processor is configured to:
classify a plurality of consignees into a first list and a second list, wherein the first list comprises one or more unique consignees and the second list comprises one or more duplicate consignees from amongst the plurality of consignees;
obtain metadata associated with the one or more duplicate consignees comprised in the second list;
select for each of the one or more duplicate consignees, at least one false duplicate verification rule from a plurality of false duplicate verification rules that is to be used for determining a veracity of the one or more duplicate consignees present in the second list, based on the metadata associated with each of the said one or more duplicate consignees; and
apply the selected at least one false duplicate verification rule on each of the one or more duplicate consignees present in the second list to determine whether a false duplicate consignee is present in the second list, wherein the false duplicate consignee is a unique consignee which is erroneously deemed as a duplicate consignee.

9. The system of claim 8, wherein the metadata associated with the one or more duplicate consignees comprises at least one of: a consignee address or a consignee geographical area code or consignee landline number, a consignee type, a consignee billing code, a consignee department-specific identifier, a consignee batch scan information, a consignee telephone contact information, and consignee media updates.

10. The system of claim 8, wherein the metadata associated with the one or more duplicate consignees comprises consignee type as one of: a doctor and a physician, wherein the selected at least one false duplicate verification rule is based on the consignee type, and wherein the processor is configured to:
for each of the one or more duplicate consignees:
query at least one of: a National Provider Identifier (NPI) Database to determine whether at least two NPIs corresponding to the duplicate consignee exist in the NPI database and a Drug Enforcement Administration (DEA) database to determine whether at least two DEAs identifiers corresponding to the duplicate consignee exist in the DEA database;
when it is determined that at least two NPIs/DEA identifiers exist corresponding to the duplicate consignee, determining whether an NPI/DEA identifier corresponding to the duplicate consignee is different than an NPI/DEA identifier corresponding to the unique consignee which corresponds to the duplicate consignee; and
identify the duplicate consignee as a false duplicate consignee when it is determined that the NPI/DEA identifier corresponding to the duplicate consignee is different than the NPI/DEA identifier corresponding to the unique consignee which corresponds to the duplicate consignee.

11. The system of claim 10, wherein the metadata associated with the one or more duplicate consignees comprises a a consignee address or a consignee geographical area code or consignee landline number, wherein the selected at least one false duplicate verification rule is based on the consignee consignee address or the consignee geographical area code or the consignee landline number, and wherein the processor is configured to:
for each of the one or more duplicate consignees:
determine whether a consignee address or a consignee geographical area code or consignee landline number of the duplicate consignee is different than a consignee address or a consignee geographical area code or consignee landline number of a unique consignee corresponding to the duplicate consignee; and
identify the duplicate consignee as a false duplicate consignee when it is determined that the consignee address or a consignee geographical area code or consignee landline number of the duplicate consignee is different than the respective consignee address or a consignee geographical area code or consignee landline number corresponding to the duplicate consignee.

12. The system of claim 8, wherein the metadata associated with the one or more duplicate consignees comprises at least one of: a consignee billing code or a consignee department-specific identifier, wherein the selected at least one false duplicate verification rule is based on at least one of: the consignee billing code or the consignee department-specific identifier, wherein the processor is configured to:
for each of the one or more duplicate consignees:
determine whether at least one of a consignee billing code or a consignee department-specific identifier of the duplicate consignee is different than a consignee billing code or a consignee department-specific identifier of a unique consignee corresponding to the duplicate consignee; and
identify the duplicate consignee as a false duplicate consignee when it is determined that at least one of the consignee billing code or the consignee department-specific identifier of the duplicate consignee is different than the consignee billing code or the consignee department-specific identifier of the unique consignee corresponding to the duplicate consignee.

13. The system of claim 8, wherein the metadata associated with the one or more duplicate consignees comprises consignee batch scan information, wherein the consignee batch scan information comprises information about one or more geographic locations where one or more historic batches of consignments were scanned, wherein the selected at least one false duplicate verification rule is based on the consignee batch scan information, and wherein the processor is configured to:
for each of the one or more duplicate consignees:
determine whether the consignee batch scan information is different than a consignee batch scan information of a unique consignee corresponding to the duplicate consignee; and
identify the duplicate consignee as a false duplicate consignee when it is determined that the consignee batch scan information of the duplicate consignee is different than the consignee batch scan information of the unique consignee corresponding to the duplicate consignee.

14. The system of claim 8, the metadata associated with the one or more duplicate consignees comprises consignee media information, wherein the consignee media information comprises consignee name change update or consignee merger and acquisition update, wherein the selected at least one false duplicate verification rule is based on the consignee media information, and wherein the processor is configured to:
for each of the one or more duplicate consignees:
determine the consignee's name or consignee merger and acquisition's update for a unique consignee corresponding to the duplicate consignee; and
identify the duplicate consignee as a false duplicate consignee when it is determined that the consignee's name or consignee merger and acquisition's update are different for the unique consignee corresponding to the duplicate consignee.

15. A computer-readable medium having computer-executable instructions stored thereon that, when executed by a processing system, cause the processing system to:
classify a plurality of consignees into a first list and a second list, wherein the first list comprises one or more unique consignees and the second list comprises one or more duplicate consignees from amongst the plurality of consignees;
obtain metadata associated with the one or more duplicate consignees comprised in the second list;
select for each of the one or more duplicate consignees, at least one false duplicate verification rule from a plurality of false duplicate verification rules that is to be used for determining a veracity of the one or more duplicate consignees present in the second list, based on the metadata associated with each of the said one or more duplicate consignees; and
apply the selected at least one false duplicate verification rule on each of the one or more duplicate consignees present in the second list to determine whether a false duplicate consignee is present in the second list, wherein the false duplicate consignee is a unique consignee which is erroneously deemed as a duplicate consignee.

16. The computer-readable medium of claim 15, wherein the wherein the metadata associated with the one or more duplicate consignees comprises at least one of: a consignee address or a consignee geographical area code or consignee landline number, a consignee type, a consignee billing code, a consignee department-specific identifier, a consignee batch scan information, a consignee telephone contact information, and consignee media updates.

17. The computer-readable medium of claim 16, wherein the metadata associated with the one or more duplicate consignees comprises consignee type as one of: a doctor and a physician, wherein the selected at least one false duplicate verification rule is based on the consignee type, and wherein the computer-executable instructions cause the processing system to:
for each of the one or more duplicate consignees:
query at least one of: a National Provider Identifier (NPI) Database to determine whether at least two NPIs corresponding to the duplicate consignee exist in the NPI database and a Drug Enforcement Administration (DEA) database to determine whether at least two DEAs identifiers corresponding to the duplicate consignee exist in the DEA database;
when it is determined that at least two NPIs/DEA identifiers exist corresponding to the duplicate consignee, determining whether an NPI/DEA identifier corresponding to the duplicate consignee is different than an NPI/DEA identifier corresponding to the unique consignee which corresponds to the duplicate consignee; and
identify the duplicate consignee as a false duplicate consignee when it is determined that the NPI/DEA identifier corresponding to the duplicate consignee is different than the NPI/DEA identifier corresponding to the unique consignee which corresponds to the duplicate consignee.

18. The computer-readable medium of claim 17, wherein the metadata associated with the one or more duplicate consignees comprises a a consignee address or a consignee geographical area code or consignee landline number, wherein the selected at least one false duplicate verification rule is based on the consignee consignee address or the consignee geographical area code or the consignee landline number, wherein the computer-executable instructions cause the processing system to:
for each of the one or more duplicate consignees:
determine whether a consignee address or a consignee geographical area code or consignee landline number of the duplicate consignee is different than a consignee address or a consignee geographical area code or consignee landline number of a unique consignee corresponding to the duplicate consignee; and
identify the duplicate consignee as a false duplicate consignee when it is determined that the consignee address or a consignee geographical area code or consignee landline number of the duplicate consignee is different than the respective consignee address or a consignee geographical area code or consignee landline number corresponding to the duplicate consignee.

19. The computer-readable medium of claim 15, wherein the metadata associated with the one or more duplicate consignees comprises at least one of: a consignee billing code or a consignee department-specific identifier, wherein the selected at least one false duplicate verification rule is based on at least one of: the consignee billing code or the consignee department-specific identifier, wherein the computer-executable instructions cause the processing system to:
for each of the one or more duplicate consignees:
determine whether at least one of a consignee billing code or a consignee department-specific identifier of the duplicate consignee is different than a consignee billing code or a consignee department-specific identifier of a unique consignee corresponding to the duplicate consignee; and
identify the duplicate consignee as a false duplicate consignee when it is determined that at least one of the consignee billing code or the consignee department-specific identifier of the duplicate consignee is different than the consignee billing code or the consignee department-specific identifier of the unique consignee corresponding to the duplicate consignee.

20. The computer-readable medium of claim 15, wherein the metadata associated with the one or more duplicate consignees comprises consignee batch scan information, wherein the consignee batch scan information comprises information about one or more geographic locations where one or more historic batches of consignments were scanned, wherein the selected at least one false duplicate verification rule is based on the consignee batch scan information, and wherein the computer-executable instructions cause the processing system to:
for each of the one or more duplicate consignees:
determine whether the consignee batch scan information is different than a consignee batch scan information of a unique consignee corresponding to the duplicate consignee; and
identify the duplicate consignee as a false duplicate consignee when it is determined that the consignee batch scan information of the duplicate consignee is different than the consignee batch scan information of the unique consignee corresponding to the duplicate consi
